(19) United States
(12) Patent Application Publication
(10) Pub. No.: US 2019/0379081 A1
(43) Pub. Date: Dec. 12, 2019

(54) Fuel Cell Module, Fuel Cell System, and Operating Method

(71) Applicant: Siemens Aktiengesellschaft, Muenchen (DE)

(72) Inventors: Hans-Jürgen BEIE, Nûrnberg (DE); Torsten BRANDT, Forchheim (DE); Frank BÄRNREUTHER, Neustadt Aisch (DE); Joachim HOFFMANN, Burgthann (DE); Arno MATTEJAT, Erlangen (DE); Ottmar VOITLEIN, Lonnerstadt (DE)

(21) Appl. No.: 16/462,477

(22) PCT Filed: Nov. 15, 2017
(86) PCT No.: PCT/EP2017/079306

§ 371 Date: May 20, 2019

(30) Foreign Application Priority Data
Nov. 18, 2016 (EP) 16002468.3

(51) Int. Cl. H01M 8/2465; H01M 8/04302; H01M 8/04303; H01M 8/04664

(52) U.S. Cl. CPC H01M 8/2465; H01M 8/04679; H01M 8/04303; H01M 8/04302

(57) ABSTRACT

A fuel cell module includes a fuel cell and an operating medium supplier for supplying operating media to the fuel cell, wherein the fuel cell has at least one stack of fuel cells, and the operating medium supplier has current terminals and has operating medium terminals, where availability of the fuel cell is further improved because the fuel cell and the operating medium supplier are separable from each other, and the fuel cell includes a module controller/regulator arranged on or in the fuel cell and is configured to bring the fuel cell to a secure state via a deactivation procedure before the fuel cell is separated from the operating medium supplier and/or to start up the fuel cell via an activation procedure after connection of the fuel cell to the operating medium supplier.

### CROSS-REFERENCE TO RELATED APPLICATIONS

This is a U.S. national stage of application No. PCT/EP2017/079306 filed Nov. 15, 2017. Priority is claimed on EP Application No. 16002468 filed Nov. 18, 2016, the content of which is incorporated herein by reference in its entirety.

### BACKGROUND OF THE INVENTION

### 1. Field of the Invention

The invention relates to a fuel cell module comprising a fuel cell unit and an operating medium supply unit for supplying the fuel cell unit with operating media.

The invention further relates to a fuel cell system with a number of these types of fuel cell modules, and also to an operating method in accordance.

### 2. Description of the Related Art

Modular-construction fuel cell systems are employed in a very wide variety of applications. A very advantageous application case lies in the environmentally friendly and silent generation of electrical energy in maritime applications, thus for example on board ships, in particular submarines or unmanned submersibles.

Fuel cell modules that usually have a rated electrical power of at least 5 kW are used in such cases.

Fuel cell modules of this type are known for example from WO 03/030291 A2, WO 2005/073075 A1 and also from the Siemens AG brochure entitled “PEM Fuel Cells for Submarines”. E10001-A930-A35-V3-7600, Siemens AG 2001, cover page.

The fuel cell modules are connected to a common operating media supply (e.g., to a common store for oxygen, hydrogen and nitrogen in each case) for the supply of operating media (e.g., hydrogen, oxygen, cooling water, nitrogen). Usually, the fuel cell modules are also electrically connected in series to obtain a desired output voltage level. As an alternative, they can also be individually connected to a DC/DC converter.

The fuel cell module has a fuel cell unit and an operating medium supply unit for supplying the fuel cell unit with operating media, where the fuel cell unit and the operating medium supply unit are connected to one another via a connecting plate arranged between the two units.

The fuel cell unit additionally has an end plate, where at least one stack of fuel cells and also a stack of humidifying cells are arranged between the connecting plate and the end plate. The end plate and the connecting plate are clamped to one another via tie rods and hold the stacks together in this way. Preferably, a cascaded fuel cell stack (i.e., a number of media-side cascade-type substacks connected behind one another) is used for an operation of the fuel cell module that is as free as possible from exhaust gas.

The operating medium supply unit is likewise connected to the connecting plate and has a terminal plate with current terminals for tapping a current generated in the fuel cells from outside of the fuel cell module as well as operating medium terminals for supplying and discharging operating media to or from the fuel cell module.

The operating medium supply unit comprises auxiliary components for the operation of the fuel cell module, in particular valves for switching on and switching off the (external) operating medium supply, pressure sensors, temperature sensors and/or water separators. Sensors and actuators of the fuel cell module are connected via corresponding signal lines and control lines to a remote controller and regulator.

A high availability of the fuel cell system and thus also of the individual modules is to be insured in such cases. In the event of a defect of a fuel cell, with the fuel cell modules described above, the entire module is usually removed from the fuel cell system and if necessary is replaced by an intact module. To do this, the entire fuel cell system, i.e., all fuel cell modules, are brought into a secure state with a deactivation procedure under the control of a higher-ranking controller and regulator. After the defective module has been replaced, the entire fuel cell system is started-up again with an activation procedure.

### SUMMARY OF THE INVENTION

The object of the present invention is to improve the availability of the fuel cell system or of the fuel cell modules even further.

This and other objects and advantages are achieved in accordance with the invention by a fuel cell module, a fuel cell system with a number of such modules and a method of operation for a fuel cell system, where in an inventive fuel cell module, the fuel cell unit and the operating medium supply unit can be separated from one another and the system comprises a module controller and/or regulator arranged on or in the fuel cell module, which is configured to bring the fuel cell unit into a secure state via a deactivation procedure before separation from the operating medium supply unit and/or to start-up the fuel cell unit via an activation procedure after a connection to the operating medium supply unit.

A “secure” state here is understood as a state in which, on the one hand, there are no dangerous contact voltages present on the fuel cell unit (e.g., voltages of less than 120 V DC) and, on the other hand, the operating medium concentration is below a prescribed limit value (e.g., hydrogen concentration of less than 4% by volume), so that a separation of the fuel cell element from the operating medium supply unit and thus contact between the fuel cells and the surrounding air does not then lead to the formation of an explosive fuel/oxygen mixture.

“To start up” is to be understood here as a controlled chemical reaction being set in train by supplying operating media to the fuel cell unit and an output voltage being generated at the fuel cell unit.

In the event of a defect of a fuel cell, the fuel cell unit can thus be safely removed from the operating medium supply unit and replaced. The operating medium supply unit can remain installed in a fuel cell system during the replacement. In particular, the terminals of the operating medium supply unit on the operating medium supply of the fuel cell system and also the current terminals do not have to be disconnected. The fuel cell system therefore does not have to be deactivated and restarted for a replacement of the fuel cell unit. This enables the time required and the effort involved for a repair of the fuel cell module or of the fuel cell system to be reduced and thus its availability to be improved.

The module controller and/or regulator arranged on or in the fuel cell module enables complicated cabling to a higher-ranking controller and/or regulator to be dispensed with and a largely autonomous control and/or regulation of the fuel cell module to be performed independently of a higher-ranking controller and/or regulator.

Preferably, the module controller and/or regulator is fastened in a detachable manner to the fuel cell unit or the operating medium supply unit and is connected via control and/or signal lines that can be released from the operating medium supply unit and/or the fuel cell unit to actuators or sensors arranged within these units. The module controller and/or regulator can thus likewise easily be replaced in the event of a defect.

The deactivation procedure advantageously comprises discharging the fuel cells and rendering them inert. “Rendering inert” is understood here as (if necessary multiple) evacuation and filling of the gas compartments of the fuel cells with an inert gas (preferably nitrogen) and/or flushing with an inert gas, until the fuel concentration is below a prescribed limit value.

The fuel cell modules can advantageously include an electrical resistance that can be switched in for electrically discharging the fuel cell unit, preferably as an element of the deactivation procedure.

Preferably the activation procedure comprises at least one, preferably all, of the following steps:
(i) Checking that sensors and actuators are correctly connected to the module controller and/or regulator,
(ii) Checking that current conductors (e.g., busbars) for conveying current generated by the fuel cell unit are correctly connected,
(iii) Filling coolant compartments of the fuel cell unit (2) with coolant,
(iv) Filling operating gas compartments of the fuel cell unit with an inert gas, preferably nitrogen after, preferably multiple, evacuation and/or flushing with inert gas, preferably nitrogen,
(v) Checking the sealing (preferably both within the modules and external),
(vi) Filling operating compartments of the fuel cell unit with operating gases (reactants),
(vii) Checking the electrochemical reaction of the fuel cells, preferably with reference to no-load voltages.

A method for filling the operating medium compartments of the fuel cell unit with operating medium is described, for example in the applicants' as yet unpublished European patent application No. 16163367.2.

Moreover, the fuel cell module preferably has one or more operating elements for starting the deactivation procedure and/or the activation procedure and/or one or more display elements for displaying a successful conclusion of the deactivation procedure and/or of the activation procedure. The operating element can be a push button, a switch or an element of a touch-sensitive display (touch screen), for example. The display element can be an optical or an acoustic signal generator or an element of a display, for example. A person can thus especially easily start the deactivation procedure and/or the activation procedure on the fuel cell module on site and receives an acknowledgement as to the time at which the fuel cell unit can be safely separated from the operating medium supply unit or the time at which the fuel cell module is again ready for operation after connection of the fuel cell unit and the operating medium supply unit.

In accordance with a very simply constructed embodiment, the fuel cell unit and the operating medium supply unit are connected to one another via a connecting plate arranged between the two units, where the connecting plate comprises a first sub-plate and a second sub-plate which can be detached from one another to separate the fuel cell unit from the operating medium supply unit.

In accordance with a further very simply constructed embodiment, the fuel cell unit is connected to the second sub-plate and has an end plate, where the at least one stack of fuel cells is arranged between the second sub-plate and the end plate, and where the second sub-plate and the end plate are clamped to one another such that they hold the stack of fuel cells together.

In accordance with a further simply constructed embodiment, the fuel cell unit is connected to the first sub-plate and comprises a terminal plate, which has the operating medium terminals, preferably also the current terminals.

For humidifying the operating gases before they are supplied to the fuel cells, a stack of humidifying cells can be arranged between the second sub-plate and the end plate, where the second sub-plate and the end plate are clamped to one another such that they simultaneously hold both the stack of fuel cells and the stack of humidifying cells together.

For simple connection of supply and discharge channels of the fuel cells and possibly the humidifying cells of the fuel cell unit to the operating medium supply unit, operating medium channels extend through the two sub-plates, preferably in the stack direction of the fuel cells.

For precise monitoring of the fuel cells, the fuel cell module preferably also comprises a cell voltage monitoring device, which is fastened detachably to the fuel cell unit and is connected via signal lines that can be disconnected from the fuel cell unit. The cell voltage monitoring device can thus also easily be replaced in the event of a defect.

It is also an object of the invention to provide an inventive fuel cell system, which comprises a number of fuel cell modules described above, which are connected to a common operating medium supply for supplying them with operating medium.

In accordance with an advantageous embodiment of this fuel cell system, for replacing a fuel cell unit of a fuel cell module during ongoing operation of the fuel cell system by releasing the two sub-plates, the fuel cell unit of this fuel cell module can be separated from the operating medium supply unit, where the operating medium supply unit remains connected to the fuel cell system however.

It is also an object of the invention to provide a method for operating a fuel cell system with a number of fuel cell modules described above in each case, which are supplied with operating medium from a common operating medium supply, where to replace a fuel cell unit of a fuel cell module during ongoing operation of the fuel cell system, the fuel cell unit of this fuel cell system is brought into a secure state via the deactivation procedure and is subsequently separated from the operating medium supply unit, and where after separation of the fuel cell unit from the operating medium supply unit, the operating medium supply unit remains connected to the fuel cell system.

It is also an object of the invention to provide a method for operating a fuel cell system with a number of fuel cell modules described above in each case, which are supplied with operating medium from a common operating medium supply, where to replace a fuel cell unit during ongoing operation of the fuel cell system and operating medium supply unit connected to the fuel cell system, the fuel cell unit is connected to the operating medium supply unit and is started-up via the activation procedure.

Of particular advantage, for replacing a fuel cell unit of a fuel cell module, the two above-described methods explained are performed after one another.

Preferably, for replacing a fuel cell unit of a fuel cell module during ongoing operation of the fuel cell system by releasing the two above-described sub-plates, the fuel cell unit of this fuel cell module is separated from the operating medium supply unit where, after separation of the fuel cell unit from the operating medium supply unit, the operating medium supply unit remains connected to the fuel cell system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention, as well as further advantageous embodiments of the invention in accordance with features of the dependent claims, is explained in greater detail below in the figures on the basis of exemplary embodiments, in which:

FIG. 1 shows a fuel cell module in accordance with the prior art;

FIG. 2 shows a fuel cell system in accordance with the prior art;

FIG. 3 shows an inventive fuel cell module in a simplified schematic diagram in its assembled state in accordance with the invention;

FIG. 4 shows the fuel cell module of FIG. 3 in its separated state in accordance with the invention;

FIG. 5 shows a plan view of the module controller and/or regulator of the fuel cell module of FIGS. 3 and 4;

FIG. 6 shows a fuel cell system in accordance with the invention;

FIG. 7 shows a detailed diagram of a first perspective view of a fuel cell module in accordance with the invention;

FIG. 8 shows a second perspective view of the fuel cell module of FIG. 7;

FIG. 9 shows a method execution sequence for a deactivation procedure of a fuel cell module in accordance with the invention; and

FIG. 10 shows a method execution sequence for an activation procedure of a fuel cell module in accordance with the invention.

### DETAILED DESCRIPTION OF THE EXEMPLARY EMBODIMENTS

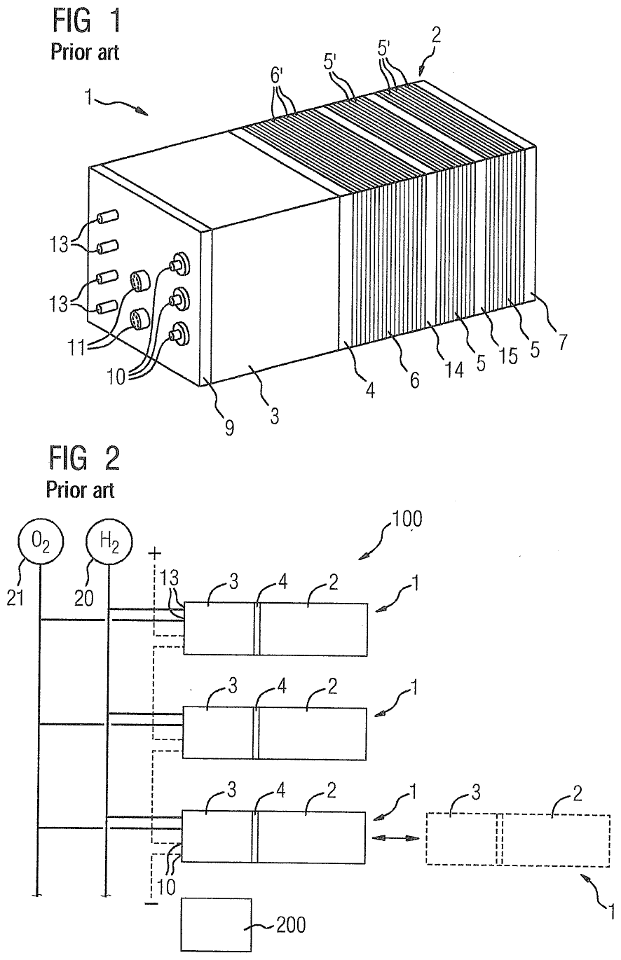

FIG. 1 shows a conventional fuel cell module 1, which has a fuel cell unit 2 and an operating medium supply unit 3 for supplying the fuel cell unit 2 with the operating media, in a simplified schematic diagram.

As shown, the fuel cell module 1 preferably has precisely one fuel cell unit 2 and precisely one operating medium supply unit 3 assigned to this fuel cell unit 2, i.e., the operating medium supply unit 3 serves only to supply this one assigned fuel cell unit 2 with operating media.

It is, however, also possible, for example, for the fuel cell module 1 to have precisely one operating medium supply unit 3 and two or more fuel cell units 2 assigned only to this unit and supplied by this unit with operating media.

The fuel cell unit 2 comprises a stack 5 of Polymer Electrolyte Membrane (PEM) fuel cells 5′ and a stack 6 of humidifying cells 6′. The stack 5′ is cascaded and to this end has two substacks with a stabilization plate 15 arranged between them. The cascading enables a very exhaust gas-free operation of the fuel cells to be made possible.

The fuel cell unit 2 and the operating medium supply unit 3 are connected to one another via a connecting plate 4 arranged between these two units.

The fuel cell unit 2 additionally has an end plate 7, where the stacks 5, 6 are arranged between the connecting plate 2 and the end plate 7. The end plate 7 and the connecting plate 4 are clamped to one another via tie rods (not shown in any greater detail) and, thus, hold the stacks 5, 6 together.

The operating medium supply unit 3 is likewise connected to the connecting plate 4 and has a terminal plate 9 with current terminals 10 for tapping a current generated in the fuel cells 5′ from outside of the fuel cell module 1, measuring sensor terminals 11 and also operating media terminals 13 for supplying and discharging operating media (oxygen, hydrogen, nitrogen) to or from the fuel cell module 1.

A further intermediate plate 14, together with the plates 4, 7, delimits the humidifying cell stack 6 or the fuel cell stack 5.

The plates 4, 14, 15 have a number of operating media channels (not shown in FIG. 1) extending through the plates. The plates 4, 7 close off the fuel cell unit 2 to the outside.

The operating medium supply unit 3 comprises auxiliary components for the operation of the fuel cell module 1, in particular valves for switching on and switching off the (external) operating medium supply, pressure sensors, temperature sensors and/or water separators.

Sensors and actuators of the fuel cell module 1 (not shown in any greater detail) are connected via corresponding terminals in the terminal plate 9 or end plate 7 and signal and control lines are connected to a higher-ranking controller and regulator. Only the measurement sensor terminals 13 are shown by way of example. Not shown are any busbars, which extend externally along the fuel cell unit 2 and convey the current generated by the fuel cells into the operating medium supply unit 3.

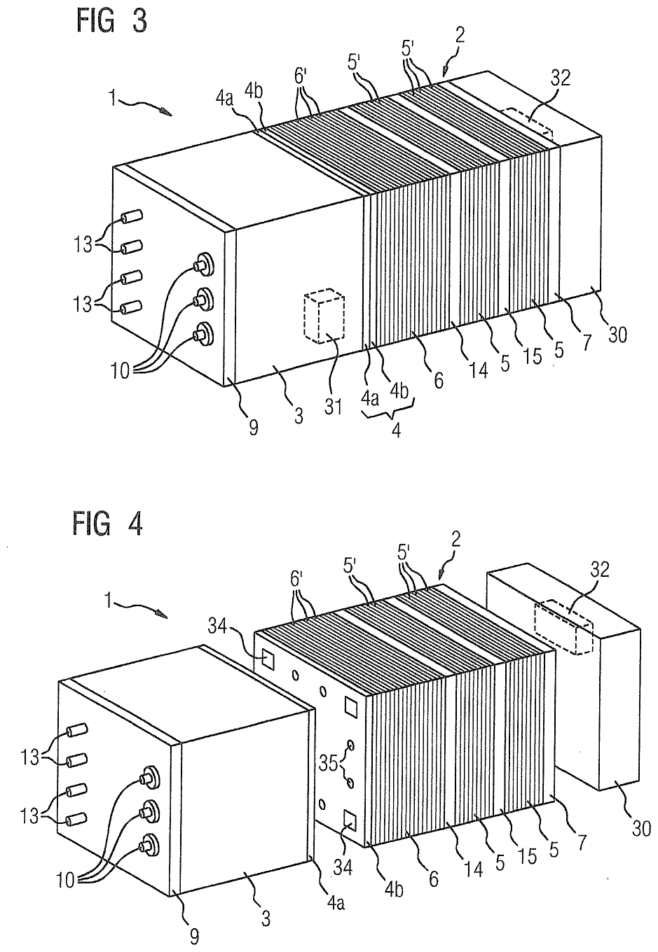

FIG. 2 shows a fuel cell system 100 with a number of fuel cell modules 1 in accordance with FIG. 1. For supply of operating media from outside, the fuel cell modules 1 are connected via the terminals 13 to a common hydrogen supply 20 and to a common oxygen supply 21. In a similar way, they can also be connected to a common nitrogen supply or cooling water supply, for example. A higher-ranking controller and/or regulator 200 serves to control and/or regulate all fuel cell modules 1 and is connected to the measurement sensor inputs 11, for example, for this purpose (see FIG. 1).

For replacing a defective fuel cell 5′ of a fuel cell module 1, the entire module 1 must be separated by the terminals 10, 11, 13 from the fuel cell system 100. To do this, deactivation and subsequent reactivation of the entire fuel cell system 100 is necessary. A deactivation and subsequent reactivation of the entire fuel cell system 100 is also necessary for a re-installation of a fuel cell module 1.

FIG. 3 shows an inventive fuel cell module 1 where, by comparison with FIG. 1, the same components are provided with the same reference characters. Unlike the fuel cell module from FIG. 1, the connecting plate 4 comprises a first sub-plate 4a and a second sub-plate 4b, which can be released from one another, in order to disconnect the fuel cell unit 2 from the operating medium supply unit 3.

To this end, the fuel cell unit 2 is connected to the second sub-plate 4b and the stacks 5, 6 are arranged between the second sub-plate 4b and the end plate 7. The second sub-plate 4b and the end plate 7 are clamped to one another such that they hold the stacks 5, 6 together. The operating medium supply unit 3 is connected to the first sub-plate 4a.

The fuel cell unit can thus be replaced very easily, where the operating medium supply unit 3 with its terminals 10, 13 can remain connected to the fuel cell system 100.

Not shown are any busbars, which extend externally along the fuel cell unit 2 and convey the current generated by the fuel cells 5′ into the operating medium supply unit 3. These busbars can be disconnected from busbars in the operating medium supply unit 3 or reconnected to the busbars via plug connections, for example.

Also not shown are elements for releasable connection of the two sub-plates 4a, 4b, as well as a seal between these two sub-plates. These can consist of screw connections, for example, which are arranged on the outer edge of the sub-plates 4a, 4b. Holes necessary for this can be arranged in the outer edge of the sub-plates 4a, 4b, for example, which project beyond an outer edge of the fuel cells 5′ or humidifying cells 6′.

For simple connection of supply and discharge channels of the fuel cells 5′ and the humidifying cells 6′ of the fuel cell unit 2 to the operating medium supply unit 3, operating medium channels extend through the two sub-plates 4a, 4b in the stack direction of the cells 5′, 6′, in a way not shown in any greater detail.

The fuel cell module 1 comprises a separate module controller and/or regulator 30, which is detachably fastened to the fuel cell unit 2 and is connected to actuators or sensors arranged in the fuel cell unit 2 via control and/or signal lines detachable from the operating medium supply unit 3 and the fuel cell unit 2. The module controller and/or regulator 30 can thus also be replaced easily in the event of a defect. In this case, the module controller and/or regulator 30 assumes significant functions of the module controller and/or regulator 200 of FIG. 2, so that the measurement sensor outputs in the terminal plate 9 can be dispensed with.

The module controller and/or regulator 30 is configured to bring the fuel cell unit 2 into a secure state via a deactivation procedure before it is separated from the operating medium supply unit 3 and to restart the fuel cell unit 2 via an activation procedure after it has been connected to the operating medium supply unit 3.

The fuel cell module 1 comprises a switchable electrical resistance 31 for electrically discharging the fuel cell unit 2 as an element of the deactivation procedure.

For precise monitoring of the fuel cells 5′, the fuel cell module 1 further comprises a cell voltage monitoring device 32, which is likewise fastened detachably to the fuel cell unit 2 and is connected via signal lines detachable from the fuel cell unit 2 to fuel cells 5 of the fuel cell unit 2. The cell voltage monitoring device 32 can thus likewise be easily replaced in the event of a defect.

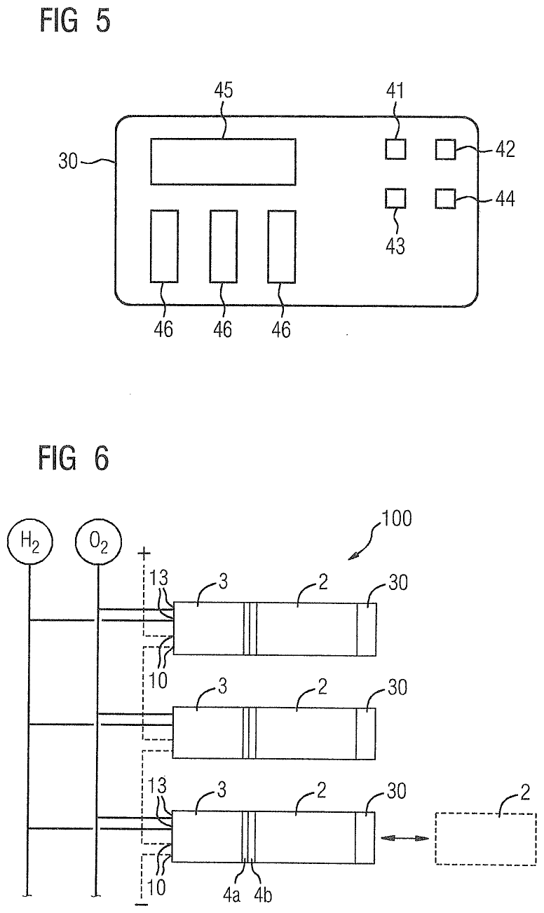

As is shown in a top view of the module controller and/or regulator 30 in FIG. 5, this unit has a first operating element 41 on its outer side (e.g., a push button) for starting the deactivation procedure and a second operating element 42 (e.g., a push button) for starting the activation procedure. In addition, it has a first display element 43 (e.g., a signal lamp) for displaying a successful conclusion of the deactivation procedure and a second display element 44 (e.g., a signal lamp) for displaying a successful conclusion of the activation procedure.

A person can thus start the deactivation procedure or activation procedure especially easily on site at the fuel cell module 1 and receives an acknowledgement as to the time at which they can safely separate the fuel cell unit 2 from the operating medium supply unit 3 or that the fuel cell module 1 is again ready for operation after a connection of the fuel cell unit 2 and operating medium supply unit 3.

The fuel cell module 1 usually has a rated electrical power of at least 5 kW for maritime applications.

An uncascaded stack can also be present instead of a cascaded stack 5.

FIG. 4 shows a fuel cell module 1 from FIG. 3 in a state in which the operating medium supply unit 3, the fuel cell unit 2, the module controller and/or regulator 30 and the cell voltage monitoring device 32 are separated from one another. Operating medium channels 34 running through the sub-plates 4a, 4b can also be seen. Seals not shown in any greater detail for sealing the operating medium channels 34 can also be located between the sub-plates 4a, 4b. Furthermore schematic tie rods 35 for clamping the sub-pate 4b to the end plate 7 are shown.

FIG. 5 shows a plan view of the outer side of the module controller and/or regulator 30 with the operating elements 41, 42 and the display elements 43, 44. Also visible are a touchscreen 45 for displaying status information and also plug-connection terminals 46 for connection of plug connectors for signal and control lines, as well as for bus communication to a higher-ranking module controller and/or regulator.

As shown with reference to a fuel cell system 100 in FIG. 6, the fuel cell unit 2 can thus be separated from the operating medium supply unit 3 and replaced in the event of a defect of a fuel cell 5′, where the operating medium supply unit 3 continues to remain connected to the fuel cell system 100. This can be done during ongoing operation of the fuel cell system 100. Deactivation and subsequent reactivation of the entire fuel cell system 100 during a replacement of an individual fuel cell unit 2 is not necessary.

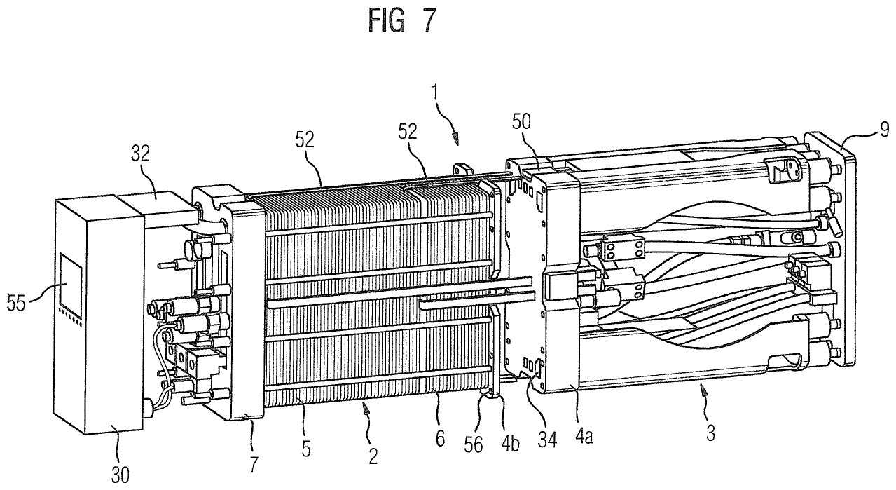

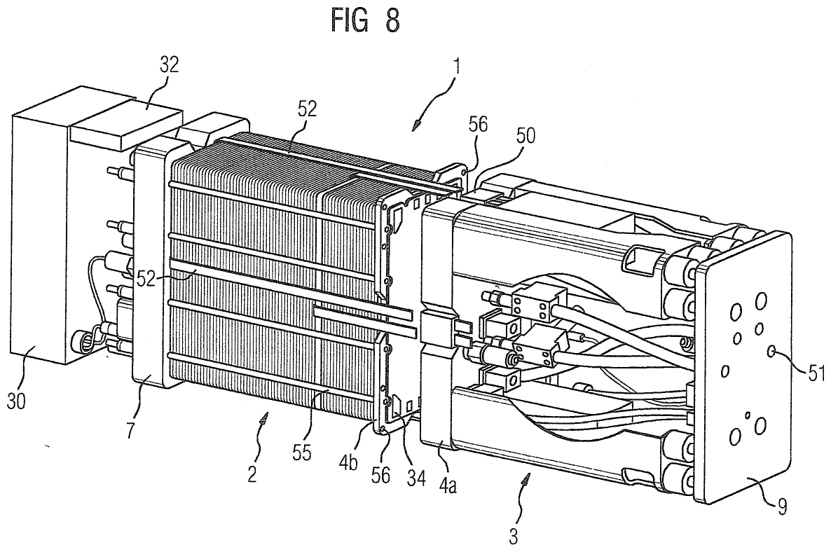

FIGS. 7 and 8 show, in two different perspective views, an inventive fuel cell module 1 in the separated state in a detailed diagram. In these figures, by comparison with the fuel cell module 1 of FIG. 3 to FIG. 5, components corresponding to one another are provided with the same reference characters. For simplification of the diagram only holes 51 of the terminals in the terminal plate 9 are shown.

Additionally visible are busbars 52 running along the fuel cell unit 2, which can be connected via plug connections 50 to electrical connecting lines in the operating medium supply unit 3 or disconnected from the unit. The module controller and/or regulator 30 now has a touchscreen 55 instead of separate operating and display elements. Also shown are tie rods 55 for clamping the plates 4b and 7 in order to hold the stacks 5 and 6 together.

The two sub-plates 4a, 4b can also have quick couplings into the operating medium channels 34 extending through them.

Also shown are holes 56 arranged on the outer edge of the sub-plates 4a, 4b for screw connections for releasable connection of the fuel cell unit 2 to the operating medium supply unit 3.

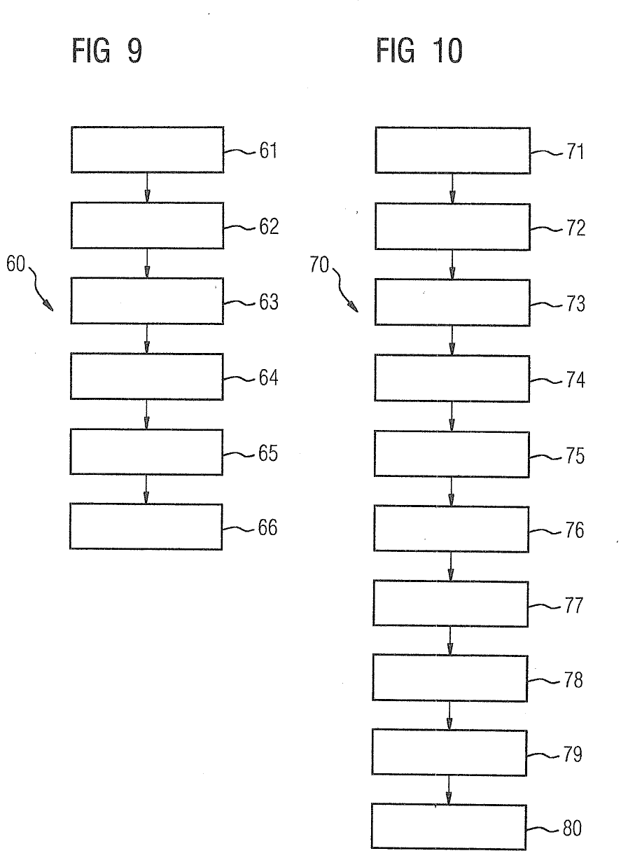

A method execution sequence 60 for a separation of a fuel cell unit 2 from an operating medium supply unit 3 is illustrated with reference to FIG. 9. The method execution sequence is explained with reference to the exemplary embodiments from FIG. 3 to FIG. 6.

The method starts during ongoing operation of the fuel cell system 100 in a step 61 with a deactivation command by an operator via the operating element 41, alternatively also directly by the module controller and/or regulator 30 or the higher-ranking controller and/or regulator 200. This deactivation command is detected by the module controller and/or regulator 30.

A deactivation procedure is then started and run automatically by the module controller and/or regulator 30. To do this, the module controller and/or regulator 30 first separates the fuel cells 5′ from the current terminals 10 (and thus electrically from the fuel cell system 100), in a step 62, via a switch and connects the discharge resistance 31 to the fuel cells 5′ of the fuel cell module 1 to be deactivated after a deactivation of the reactants and handling of the operating gas compartments.

In a next step 63, the module controller and/or regulator 30 renders the fuel cells 5′ inert. This rendering inert comprises an (if necessary multiple) evacuation and filling of the gas compartments of the fuel cells with nitrogen and/or flushing with nitrogen, until the hydrogen concentration falls below a predetermined limit value.

Subsequently, in a step 64, the coolant compartments of the fuel cell unit 2 are emptied.

The module controller and/or regulator 30 signals a successful conclusion of the deactivation procedure to an operator in a step 65 by corresponding activation of the display element 43.

Thereafter an operator, in a step 66, can separate the module controller and/or regulator 30, the fuel cell unit 2 and the operating medium supply unit from one another.

Illustrated with reference to FIG. 10 is a method execution sequence for a connection of a fuel cell unit 2 and an operating medium supply unit 3. The method execution sequence is likewise explained with reference to the exemplary embodiments of FIGS. 3 to 6.

The method starts during ongoing operation of the fuel cell system 100, in a step 71, with a mechanical connection of the fuel cell unit 2 and the operating medium supply unit 3 by an operator. Moreover, the module controller and/or regulator 30 is connected electrically and mechanically to the operating medium supply unit 3.

Subsequently, in a step 72, the operator creates an activation command by actuating the operating element 42. This actuation command is detected by the module controller and/or regulator 30.

An activation procedure is then started and run automatically by the module controller and/or regulator 30.

Here, in a first step 73, the correct connection of valves and sensors to the module controller and/or regulator 30 is checked.

In a further step 74 a correct connection of current conductors (e.g., busbars), which carry the current generated by the fuel cells, is checked.

Next, in a step 75, the coolant compartments of the fuel cell unit 2 are then filled with coolant (e.g., deionized water), which is supplied to the fuel cell module 1 from outside (e.g., via an auxiliary device, as in the applicant's as yet unpublished European patent application no. 16163367.2 or directly via the operating medium supply of the connected fuel cell system) of the operating medium supply unit 3. This can also comprise a subsequent ventilation and/or degasification of the coolant compartments.

Thereafter, in a step 76, the operating gas compartments of the fuel cells 5 are suitably prepared with inert gas, evacuation and/or flushing, in order, in a step 77, to perform a pressure retention test/sealing test with different levels of filling of the gas compartments of the fuel cell unit 2 (e.g., via an auxiliary device, as in the applicant's as yet unpublished European patent application no. 16163367.2 or directly via the operating medium supply of the connected fuel cell system).

Subsequently, in a step 78, the reactants can be supplied and the electrochemical reaction, preferably based on the no-load voltages, can be checked.

The module controller and/or regulator 30 signals a successful conclusion of the activation procedure to an operator in a step 79 by corresponding activation of the display element 44.

Thereafter, in a step 80, the fuel cell module 2 can be connected to the fuel cell system 100.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-15. (canceled)

16. A fuel cell module comprising:
a fuel cell unit having at least one stack of fuel cells comprising a cascaded stack of fuel cells; and
an operating medium supply unit for supplying the fuel cell unit with operating media, the operating medium supply unit having current terminals for tapping a current generated in the fuel cells from outside of the fuel cell module and operating medium terminals for supplying and discharging operating media to or from the fuel cell module;
wherein the fuel cell unit and the operating medium supply unit are separable from one another; and
wherein the fuel cell module comprises a module controller/regulator arranged in or on the fuel cell module, the module controller/regulator being configured to one of (i) bring the fuel cell unit to a secure state via a deactivation procedure before the fuel cell is separated from the operating medium supply unit and (ii) start-up the fuel cell unit via an activation procedure after the fuel cell unit is connected to the operating medium supply unit.

17. The fuel cell module as claimed in claim 16, wherein the module controller/regulator is detachably fastened to one of (i) the fuel cell unit and (ii) the operating medium supply unit and is connected, via at least one of (i) control lines and (ii) signal lines detachable from at least one of the operating medium supply unit and the fuel cell unit, to actuators or sensors arranged in each of said units.

18. The fuel cell module as claimed in claim 16, wherein the deactivation procedure comprises discharging and rendering the fuel cells inert.

19. The fuel cell module as claimed in claim 16, further comprising:
a switchable electrical resistance for electrical discharging of the fuel cell unit.

20. The fuel cell module as claimed in claim 16, wherein the activation procedure comprises at least one of the following steps:
checking whether sensors and actuators are correctly connected to the module controller/regulator,
checking whether current conductors for conveying current generated by the fuel cell unit are correctly connected,
filling coolant compartments of the fuel cell unit with coolant,
filling operating gas compartments of the fuel cell unit with an inert gas,
checking the sealing,
filling operating compartments of the fuel cell unit with operating gases,
checking the electrochemical reaction of the fuel cells based on no-load voltages.

21. The fuel cell module as claimed in claim 20, wherein all the steps are performed.

22. The fuel cell module as claimed in claim 16, further comprising:
at least one (i) at least one operating element for starting at least one of the deactivation procedure and the activation procedure and (ii) at least one display element for displaying a successful conclusion of at least one of the deactivation procedure and the activation procedure.

23. The fuel cell module as claimed in claim 16, wherein the fuel cell unit and the operating medium supply unit are connected to one another via a connecting plate arranged between the fuel cell unit and the supply unit; and wherein the connecting plate comprises a first sub-plate and a second sub-plate, which are detachable from one another to separate the fuel cell unit from the operating medium supply unit.

24. The fuel cell module as claimed in claim 23, wherein the fuel cell unit is connected to the second sub-plate; wherein the at least one stack of fuel cells is arranged between the second sub-plate and an end plate; and wherein the second sub-plate and the end plate are clamped to one another such the stack of fuel cells together are held together by the clamped together second sub-plate and end plate.

25. The fuel cell module as claimed in one of claim 23, wherein the operating medium supply unit is connected to the first sub-plate and comprises a terminal plate which has the operating medium terminals.

26. The fuel cell module as claimed claim 25, wherein the terminal plate additionally includes the current terminals.

27. The fuel cell module as claimed in claim 24, wherein the operating medium supply unit is connected to the first sub-plate and comprises a terminal plate which has the operating medium terminals.

28. The fuel cell module as claimed in claim 27, wherein the terminal plate additionally includes the current terminals.

29. The fuel cell module as claimed in claim 23, further comprising:
a stack of humidifying cells arranged between the second sub-plate and the end plate;
wherein the second sub-plate and the end plate are clamped to one another such that the second sub-plate and end plate simultaneously hold the stack of humidifying cells and the stack of fuel cells together.

30. The fuel cell module as claimed in claim 23, wherein operating medium channels extend through the first and second sub-plates.

31. A fuel cell system with a plurality of fuel cell modules as claimed in claim 16 and connected to a common operating medium supply to supply operating media.

32. A method for operating a fuel cell system including a plurality of fuel cell modules which are each supplied with operating media from a common operating medium supply, wherein in order to replace a fuel cell unit of a fuel cell module during ongoing operation of the fuel cell system, the method comprising:
bringing the fuel cell unit of the fuel cell module to a secure state via a deactivation procedure; and
separating the fuel cell unit from an operating medium supply unit;
wherein, after separation of the fuel cell unit from the operating medium supply unit, the operating medium supply unit remains connected to the fuel cell system.

33. A method for operating a fuel cell system including a plurality of fuel cell modules which are supplied with operating media from a common operating medium supply, the method comprising:
operating the fuel cell system; and
connecting a fuel cell unit to an operating medium supply unit and starting-up the fuel cell unit via an activation procedure, during ongoing operation of the fuel cell system and operating medium supply unit connected to the fuel cell system.

34. The method as claimed in claim 32, wherein in order to replace a fuel cell unit of a fuel cell module, said bringing step is performed, said separating step is performed, the fuel cell system is operated, and a fuel cell unit is connected to an operating medium supply unit and the fuel cell unit is started-up via an activation procedure, during ongoing operation of the fuel cell system and operating medium supply unit connected to the fuel cell system.

35. The method as claimed in claim 33, wherein in order to replace a fuel cell unit of a fuel cell module, said bringing step is performed, said separating step is performed, the fuel cell system is operated, and a fuel cell unit is connected to an operating medium supply unit and the fuel cell unit is started-up via an activation procedure, during ongoing operation of the fuel cell system and operating medium supply unit connected to the fuel cell system.
